(19) United States
(12) Patent Application Publication
(10) Pub. No.: US 2008/0009776 A1
(43) Pub. Date: Jan. 10, 2008

(54) Apparatus and method for monitoring and controlling the transmissibility of mechanical vibration energy during dynamic motion therapy

(75) Inventor: Titi Trandafir, S. Plainfield, NJ (US)

Correspondence Address: CARTER, DELUCA, FARRELL & SCHMIDT, LLP, 445 BROAD HOLLOW ROAD, SUITE 225, MELVILLE, NY, 11747, US

(73) Assignee: Juvent Inc., Somerset, NJ (US)

(21) Appl. No.: 11/796,340

(22) Filed: Apr. 27, 2007

Related U.S. Application Data
(63) Continuation-in-part of application No. 11/388,286, filed on Mar. 24, 2006.

(51) Int. Cl. A61H 1/00

(52) U.S. Cl. 601/53; 601/90

(57) ABSTRACT

Apparatus and methods for therapeutically treating bone fractures, osteopenia, osteoporosis, or other tissue conditions, postural instability, or other conditions, such as cystic fibrosis, Crohn's disease and kidney and gall bladder stones. An oscillating platform apparatus supports a body to be treated on a non-rigidly supported upper plate. An oscillator is positioned within the oscillating platform apparatus and is configured to impart an oscillating force on the body. The body can be supported by a support structure of which a portion thereof contacts the non-rigidly supported upper plate. Two accelerometers are mounted to the oscillating platform apparatus for determining the acceleration and mass of the body being. Once the mass of the body is determined, the amplitude of the frequency of the oscillating force and/or frequency of the oscillating force is adjusted to provide a desired therapeutic treatment to the patient. Information received from the two accelerometers is also used to determine the posture of the patient and the transmissibility of the mechanical vibration energy generated by the oscillating force through the body.

### CROSS REFERENCE TO RELATED APPLICATION

This patent application is a continuation in part of U.S. patent application Ser. No. 11/388,286 filed on Mar. 24, 2006; the entire contents of which are incorporated herein by reference.

### BACKGROUND

The present disclosure generally relates to the field of stimulating tissue growth and healing, and more particularly to an apparatus and method for monitoring and controlling the transmissibility of mechanical vibration energy during dynamic motion therapy. More specifically, the present disclosure relates to therapeutically treating damaged tissues, bone fractures, osteopenia, osteoporosis, or other tissue conditions, as well as postural instability, using dynamic motion therapy and mechanical impedance methods to predict and maximize the transmissibility of mechanical vibration energy through a patient's body.

When damaged, tissues in a human body such as connective tissues, ligaments, bones, etc. all require time to heal. Some tissues, such as a bone fracture in a human body, require relatively longer periods of time to heal. Typically, a fractured bone must be set and then the bone can be stabilized within a cast, splint or similar type of device. This type of treatment allows the natural healing process to begin. However, the healing process for a bone fracture in the human body may take several weeks and may vary depending upon the location of the bone fracture, the age of the patient, the overall general health of the patient, and other factors that are patient-dependent. Depending upon the location of the fracture, the area of the bone fracture or even the patient may have to be immobilized to encourage complete healing of the bone fracture. Immobilization of the patient and/or bone fracture may decrease the number of physical activities the patient is able to perform, which may have other adverse health consequences. Osteopenia, which is a loss of bone mass, can arise from a decrease in muscle activity, which may occur as the result of a bone fracture, bed rest, fracture immobilization, joint reconstruction, arthritis, and the like. However, this effect can be slowed, stopped, and even reversed by reproducing some of the effects of muscle use on the bone. This typically involves some application or simulation of the effects of mechanical stress on the bone.

Promoting bone growth is also important in treating bone fractures, and in the successful implantation of medical prostheses, such as those commonly known as “artificial” hips, knees, vertebral discs, and the like, where it is desired to promote bony ingrowth into the surface of the prosthesis to stabilize and secure it. Numerous different techniques have been developed to reduce the loss of bone mass. For example, it has been proposed to treat bone fractures by application of electrical voltage or current signals (e.g., U.S. Pat. No. 4,105,017; 4,266,532; 4,266,533, or 4,315,503). It has also been proposed to apply magnetic fields to stimulate healing of bone fractures (e.g., U.S. Pat. No. 3,890,953). Application of ultrasound to promoting tissue growth has also been disclosed (e.g., U.S. Pat. No. 4,530,360).

While many suggested techniques for applying or simulating mechanical loads on bone to promote growth involve the use of low frequency, high magnitude loads to the bone, this has been found to be unnecessary, and possibly also detrimental to bone maintenance. For instance, high impact loading, which is sometimes suggested to achieve a desired high peak strain, can result in fracture, defeating the purpose of the treatment.

It is also known in the art that low level, high frequency stress can be applied to bone, and that this will result in advantageous promotion of bone growth. One technique for achieving this type of stress is disclosed, e.g., in U.S. Pat. Nos. 5,103,806; 5,191,880; 5,273,028; 5,376,065; 5,997,490; and 6,234,975, the entire contents of each of which are incorporated herein by reference. In this technique (referred to as dynamic motion therapy), the patient is supported by an oscillating platform apparatus that can be actuated to oscillate vertically, so that resonant vibrations caused by the oscillation of the platform, together with acceleration brought about by the body weight of the patient, provides stress levels in a frequency range sufficient to prevent or reduce bone loss and enhance new bone formation. The peak-to-peak vertical displacement of the platform oscillation may be as little as 2 mm.

However, these systems and associated methods often depend on an arrangement whereby the operator or user must measure the weight of the patient and make adjustments to the frequency of oscillation to achieve the desired therapeutic effect. U.S. Pat. No. 6,843,776 discloses an oscillating platform apparatus that automatically measures the weight of the patient and adjusts characteristics of the oscillation force as a function of the measured weight, to therapeutically treat damaged tissues, bone fractures, osteopenia, osteoporosis, or other tissue conditions.

It is an aspect of the present disclosure to provide an alternative oscillating platform apparatus and associated circuitry for determining the weight of the patient using two angular measurements and making adjustments to the frequency of oscillation and/or the amplitude of the frequency of oscillation in accordance with the calculated weight of the patient to achieve the desired therapeutic effect.

It is also known in the art that the application of low level, high frequency stress is effective in treating postural instability. A method of using resonant vibrations caused by the oscillation of a vibration table or unstable vibrating platform for treating postural instability is described in U.S. Pat. No. 6,607,497 B2; the entire contents of which are incorporated herein by reference. The method includes the steps of (a) providing a non-invasive dynamic therapy device having a vibration table with a non-rigidly supported platform; (b) permitting the patient to rest on the non-rigidly supported platform for a predetermined period of time; and (c) repeating the steps (a) and (b) over a predetermined treatment duration. Step (b) includes the steps of (b1) measuring a vibrational response of the patient's musculoskeletal system using a vibration measurement device; (b2) performing a frequency decomposition of the vibrational response to quantify the vibrational response into specific vibrational spectra; and (b3) analyzing the vibrational spectra to evaluate at least postural stability.

The method described in U.S. Pat. No. 6,607,497 B2 entails the patient standing on the vibration table or the unstable vibrating platform. The patient is then exposed to a vibrational stimulus by the unstable vibrating platform. The unstable vibrating platform causes a vibrational perturbation of the patient's neuro-sensory control system. The vibrational perturbation causes signals to be generated within at least one of the patient's muscles to create a measurable response from the musculoskeletal system. These steps are repeated over a predetermined treatment duration for approximately ten minutes a day in an effort to improve the postural stability of the patient.

The patient undergoing vibrational treatment for treating postural instability and/or the promotion of bone growth, as described above, may experience a level of discomfort due to whole-body vibration acceleration. The level of discomfort caused by vibration acceleration depends on the vibration frequency, the vibration direction, the point of contact with the body, and the duration of the vibration exposure. It is desirable to monitor at least one mechanical response of the body during vibrational treatment in an effort to control the at least one mechanical response to influence comfort level, as well as to determine patient- and treatment-related characteristics. Two mechanical responses of the body that are often used to describe the manner in which vibration causes the body to move are transmissibility and mechanical impedance.

The transmissibility shows the fraction of the vibration which is transmitted from, say, the vibration table or oscillating platform apparatus to the head of the patient. The transmissibility of the body is highly dependent on vibration frequency, vibration axis and body posture. Vertical vibration on the non-invasive dynamic therapy device causes vibration in several axes at the head; for vertical head motion, the transmissibility tends to be greatest in the approximate range of 3 to 10 Hz.

The mechanical impedance of the body shows the force that is required to make the body move at each frequency. Although the impedance depends on body mass, the vertical impedance of the human body usually shows a resonance at about 5 Hz. The mechanical impedance of the body, including this resonance, has a large effect on the manner in which vibration is transmitted through seats.

Accordingly, it is an aspect of the present disclosure to use mechanical impedance methods to predict and make efforts to maximize the transmissibility of the mechanical vibration energy through a patient standing on an oscillating platform apparatus and performing exercises and/or being treated using dynamic motion therapy for bone fractures, osteopenia, osteoporosis, or other tissue conditions, postural instability, or other conditions, such as cystic fibrosis, Crohn's disease and kidney and gall bladder stones, as described in U.S. Provisional Patent Application Ser. No. 60/602,495 filed on Aug. 18, 2004; the entire contents of the provisional patent application are incorporated herein by reference.

It is also an aspect of the present disclosure to use mechanical impedance methods in designing a seat or other support structure to be supported by the oscillating platform apparatus which will maximize the transmissibility of the mechanical vibration energy through the oscillating platform apparatus-seat/support structure-patient interface.

### SUMMARY

The embodiments described herein satisfy the aspects described above. More particularly, apparatus and methods according to various embodiments of the disclosure are disclosed which automatically measure the weight of the patient and adjust dynamic motion treatment characteristics such as, for example, the frequency of oscillation and/or the amplitude of the frequency of oscillation of an oscillating platform apparatus of a dynamic motion therapy system.

The apparatus and methods according to various embodiment of the disclosure further use mechanical impedance methods to predict and make efforts to maximize the transmissibility of the mechanical vibration energy through a patient standing on the oscillating platform apparatus and performing exercises and/or being treated using dynamic motion therapy for bone fractures, osteopenia, osteoporosis, or other tissue conditions, postural instability, or other conditions, such as cystic fibrosis, Crohn's disease and kidney and gall bladder stones, as described in U.S. patent application Ser. No. 11/207,335 filed on Aug. 18, 2005.

The disclosure further discloses using mechanical impedance methods in the design of a seat or other support structure to be supported by the oscillating platform apparatus and used by a patient during dynamic motion therapy for maximizing the transmissibility of the mechanical vibration energy through the oscillating platform apparatus-seat/support structure-patient interface. An oscillating platform apparatus according to the invention is also referred to as an “oscillating platform” or as a “mechanical stress platform.”

One aspect of apparatus and methods according to various embodiments of the disclosure focuses on a platform for therapeutically treating bone fractures, osteopenia, osteoporosis, or other tissue conditions, postural instability, or other conditions, such as cystic fibrosis, Crohn's disease and kidney and gall bladder stones, having the ability to automatically measure the mass of the body being supported by the platform. An oscillating actuator is positioned within the oscillating platform apparatus and is configured to impart an oscillating force on the body.

Circuitry associated with the oscillating platform apparatus automatically determines the mass or weight of the body being supported on the oscillating platform apparatus. Once the mass of the body is determined, at least one operating parameter (the amplitude of a frequency of the oscillating force and/or frequency of the oscillating force) of the oscillating actuator is adjusted using at least one feedback signal (closed loop control) to provide a desired therapeutic treatment to the patient.

The associated circuitry includes two accelerometers mounted to the oscillating platform apparatus and a digital signal processor for receiving information from the two accelerometers and for transmitting control signals to the oscillating actuator to control the operating parameters of the oscillating actuator accordingly. One accelerometer is mounted to an upper or vibrating plate of the oscillating platform apparatus and the other accelerometer is mounted to a drive or vibrating lever within the oscillating platform apparatus.

The accelerometer mounted to the upper plate transmits patient acceleration information during dynamic motion therapy to the digital signal processor for use in determining the acceleration of the patient either standing on the platform or being supported by a support structure resting on the platform in real time. The digital signal processor transmits a feedback signal whose amplitude is adjusted to the oscillating actuator. The feedback signal is used to maintain a predetermined number used for automatic gain control (closed loop control) within a predetermined range having predetermined upper and lower limits. The digital signal processor adds the predetermined number and the acceleration of the patient continuously or periodically during dynamic motion therapy to determine the average acceleration of the patient over time. The average acceleration is stored within a memory of the processor to be used for patient monitoring and other purposes.

The accelerometer mounted to the drive lever transmits tilt information to the digital signal processor and accordingly functions as a patient sensing device (determines presence of patient), weight monitoring sensor, transmissibility (dynamic stiffness) coefficient sensor, and patient compliance monitor. This accelerometer transmits a first angular measurement to the digital signal processor after power-on and before the patient stands on the upper plate (or is supported by a support structure resting on the platform). This angular measurement is used to determine the initial angle of the upper plate which is dependent on the actual horizontality of the installation surface upon which the oscillating platform apparatus rests. Another angular measurement is received by the digital signal processor from this accelerometer after the patient stands on the upper plate (or is supported by the support structure resting on the platform) and before the oscillating actuator is actuated. This angular measurement is used together with the other angular measurement for calibrating the oscillating platform apparatus and for calculating the mass or weight of the patient using conventional weight/angle equations. The weight is preferably stored in a memory of the digital processor.

It is contemplated that if the digital signal processor has not received patient acceleration information or angular measurements after a predetermined time period from the respective accelerometers, the digital signal processor turns off the oscillating actuator. This conserves power when a patient is not standing on the oscillating platform apparatus or being supported by the support structure, such as a seat or exercise equipment, resting on the oscillating platform apparatus.

During dynamic motion therapy, the digital signal processor determines and monitors the weight of the patient. The weight of the patient is continuously in real time or periodically compared to the original stored weight to determine the posture of the patient and accordingly, the transmissibility of the mechanical vibration energy through the patient or oscillating platform apparatus-seat/support structure-patient interface, since the posture of the patient and dynamic stiffness of the seat/support structure affects the transmissibility of the mechanical vibration energy through the patient.

If the calculated weight during dynamic motion therapy differs significantly (i.e., more than a predetermined threshold) from the original stored weight, the digital signal processor determines that the patient's posture changed thereby decreasing or increasing the transmissibility of the mechanical vibration energy depending on whether the weight decreased (transmissibility decreased) or increased (transmissibility increased). If the weight decreased, it can be assumed that the patient has deviated from or is not compliant with the dynamic motion therapy treatment protocol. Accordingly, by adjusting the posture and/or dynamic stiffness of the seat (or other support structure) resting on the oscillating platform apparatus to bring the calculated weight to approximate the original stored weight, the transmissibility of the mechanical vibration energy through the patient or oscillating platform apparatus-seat/support structure-patient interface can be influenced, as well as dynamic loading, for maximizing the treatment effects caused by dynamic motion therapy.

Objects, features and advantages of various apparatus and methods according to various embodiments of the disclosure include but not limited to:

(1) providing the ability to automatically determine the weight of a body and adjust the amplitude of the frequency of the oscillating force and/or frequency of the oscillating force used to therapeutically treat damaged tissues, bone fractures, osteopenia, osteoporosis, or other tissue conditions, postural instability, or other conditions, such as cystic fibrosis, Crohn's disease and kidney and gall bladder stones;

(2) providing the ability to therapeutically treat tissues in a body to reduce or prevent osteopenia or osteoporosis;

(3) providing the ability to therapeutically treat damaged tissues, bone fractures, osteopenia, osteoporosis, or other tissue conditions in a body at a frequency effective to promote tissue or bone healing, growth, and/or regeneration;

(4) providing an apparatus adapted to automatically therapeutically treat damaged tissues, bone fractures, osteopenia, osteoporosis, or other tissue conditions in a body;

(5) providing the ability to turn an oscillating actuator on and off based on the existence of a body on an oscillator platform apparatus;

(6) providing the ability to continuously or periodically monitor a patient's posture and accordingly influence the transmissibility of the mechanical vibration energy through the patient's body;

(7) providing the ability to use mechanical impedance methods to predict the transmissibility of a seat using the dynamic stiffness of the seat and the apparent mass of the body;

(8) providing the ability to measure the acceleration of a patient undergoing dynamic motion therapy without placing sensors or other objects on the patient's body; and

(9) providing the ability to custom design a support structure, such as a seat, exercise device, etc., having maximum transmissibility of the mechanical vibration energy through the oscillating platform apparatus-support structure-patient interface.

### BRIEF DESCRIPTION OF THE DRAWINGS

FIG. 1 is a top plan view of an oscillating platform apparatus of a dynamic motion therapy system according to the disclosure, viewed through the top plate, and showing the internal mechanism of the oscillating platform apparatus;

FIG. 2 is a side sectional view taken along line 1-1 in FIG. 1, and partially cut away to show details of the connection of the oscillating actuator to the drive lever and the arrangement of the two accelerometers;

FIG. 3 is an exploded perspective view of the oscillating platform apparatus shown in FIG. 1, and partially cut away to show the internal mechanism of the oscillating platform apparatus;

FIG. 4 is schematic block diagram of the dynamic motion therapy system in accordance with the present disclosure and showing the oscillating platform apparatus shown by FIG. 1.

FIG. 5 is a perspective view illustrating an oscillating platform apparatus having a supporting mechanism for receiving a support structure;

FIG. 6 is a perspective view illustrating a kneeling chair of a kneeling chair support structure being mounted to the supporting mechanism of FIG. 5;

FIG. 7 is a perspective view illustrating the kneeling chair support structure mounted to the supporting mechanism of FIG. 5; and

FIG. 8 is a perspective view illustrating a patient being treated with the oscillating platform apparatus while being supported by the kneeling chair support structure.

### DETAILED DESCRIPTION OF PREFERRED EMBODIMENTS

Apparatus and methods in accordance with various embodiments of the disclosure are for therapeutically treating tissue damage, bone fractures, osteopenia, osteoporosis, or other tissue conditions, postural instability, or other conditions, such as cystic fibrosis, Crohn's disease and kidney and gall bladder stones. Furthermore, apparatus and methods in accordance with various embodiments of the disclosure provide a dynamic motion therapy system having an oscillating platform apparatus that is highly stable, and relatively insensitive to positioning of the patient on the platform, while providing low displacement, high frequency mechanical loading of bone tissue sufficient to promote healing and/or growth of tissue damage, bone tissue, or reduce, reverse, or prevent osteopenia and osteoporosis, and other tissue conditions, postural instability, or other conditions, such as cystic fibrosis, Crohn's disease and kidney and gall bladder stones.

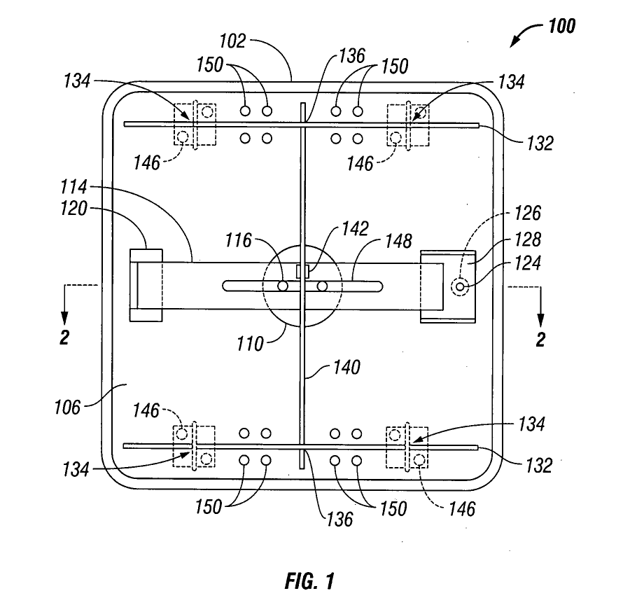

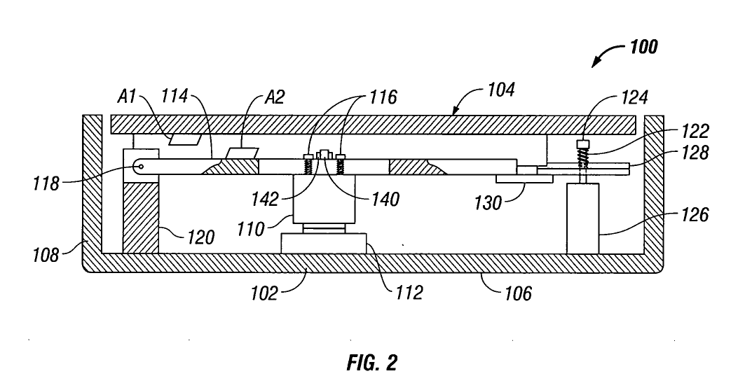

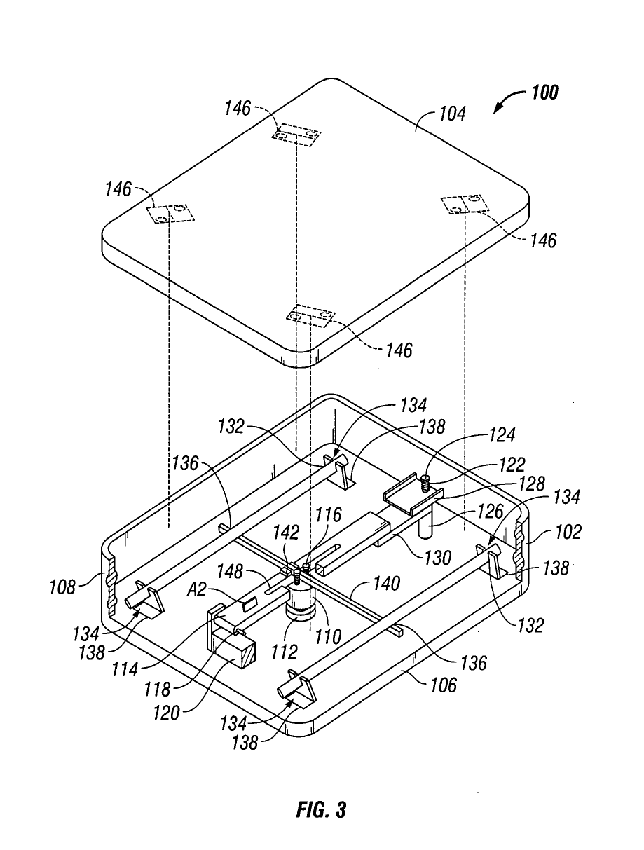

FIGS. 1-4 illustrate an oscillating platform apparatus according to an embodiment of the disclosure. FIG. 1 shows a top plan view of the platform 100, which is housed within a housing 102. The oscillating platform apparatus 100 is also referred to as an oscillating platform, platform, vibration table or a mechanical stress platform. The housing 102 includes a non-rigidly supported upper or top plate 104 (best seen in FIGS. 2 and 3), lower plate 106, and side walls 108. Note that the upper plate 104 is generally rectangular or square-shaped, but can otherwise be geometrically configured for supporting a body in an upright position on top of the upper plate 104, or in a position otherwise relative to the platform 100. Other configurations or structures can be also used to support a body in an upright position, above, or otherwise relative to, the platform.

FIG. 1 shows the platform 100 through top plate 104, so that the internal mechanism can be illustrated. An oscillating actuator 110 mounts to lower plate 106 by oscillator mounting plate 112 (see FIG. 2), and connects to drive lever 114 by one or more connectors 116.

Oscillating actuator 110 causes drive lever 114 to rotate a fixed distance around drive lever pivot point 118 on drive lever mounting block 120. The oscillating actuator 110 actuates the drive lever at a first predetermined frequency. The motion of the drive lever 114 around the drive lever pivot point 118 is damped by a damping member such as a spring 122, best seen in FIGS. 2 and 3. The damping member or spring 122 creates an oscillation force to counteract the mass on platform and the voice coil 126. The oscillation force of the spring 122 operates at a second predetermined frequency. The second predetermined frequency is preferably equal to the first predetermined frequency. One end of spring 122 is connected to spring mounting post 124, which is supported by mounting block 126, while the other end of spring 122 is connected to distributing lever support platform 128. Distributing lever support platform 128 is connected to drive lever 114 by connecting plate 130 (FIG. 3). Driver lever 114 supports primary distributing lever 140, which rotates about primary distributing lever pivot point 142. Secondary distributing levers 132 are connected to primary distributing lever 140 by linkages 136, which may be simply mutually engaging slots. Secondary distributing levers 132 rotate about pivot points 134 in a manner similar to that described above for the primary distributing lever 140 and are supported by supports 138 extending from lower plate 106.

Upper plate 104 is supported by a plurality of contact points 146, which can be adjustably secured to the underside of the upper plate 104, and which contact the upper surfaces of primary distributing levers 132, secondary distributing levers 132, or some combination thereof.

In operation, a patient (not shown) sits or stands on the upper plate 104 (or is supported by a support structure resting on the platform 100), which is in turn supported by a combination of the primary distributing lever 140 and secondary distributing levers 132. When the platform 100 of the dynamic motion therapy system 400 is operating, oscillating actuator 110 moves up and down in a reciprocal motion, causing drive lever 114 to oscillate about its pivot point 118 at a first predetermined frequency. The rigid connection between the drive lever 114 and distributing lever support platform 128 results in this oscillation being damped by the force created or exerted by the spring 122, which can desirably be driven at a second predetermined frequency, in some embodiments its resonance frequency and/or harmonic or sub-harmonics of the resonance frequency. The oscillatory displacement is transmitted from the distributing lever support platform 128 to primary distributing lever 140 and thus to secondary distributing levers 132. One or more of the primary distributing lever 140 and/or secondary distributing levers 132 distribute the motion imparted by the oscillation to the free-floating upper plate 104 by virtue of contact points 146. The oscillatory displacement is then transmitted to the patient supported by the upper plate 104, thereby imparting high frequency, low displacement mechanical loads to the patient's tissues, such as the bone structure of the patient supported by the platform 100.

In this particular embodiment, the oscillating actuator 110 can be a piezoelectric or electromagnetic transducer configured to generate a vibration. Other conventional types of transducers may be suitable for use with the invention. For example, if small ranges of displacements are contemplated, e.g. approximately 0.002 inches (0.05 mm) or less, then a piezoelectric transducer, a motor with a cam, or a hydraulic-driven cylinder can be employed. Alternatively, if relatively larger ranges of displacements are contemplated, then an electromagnetic transducer can be employed.

Suitable electromagnetic transducers, such as a cylindrically configured moving coil high performance linear actuator may be obtained from BEI Motion Systems Company, Kimco Magnetic Division of San Marcos, Calif. Such an electromagnetic transducer may deliver a linear force, without hysteresis, for coil excitation in the range of 10-100 Hz, and short-stroke action in ranges as low as 0.8 inches (20 mm) or less.

Furthermore, the spring 122 can be a conventional type spring configured to resonate at a predetermined frequency as a function of the mass of the patient, or at the resonance frequency. The resonance frequency of the spring can be determined from the equation:
Resonance Frequency (Hz)=[Spring Constant (k)/Mass (lbs)]^{1/2}
For example, if the oscillating platform apparatus is to be designed for treatment of humans, the spring 122 can be sized to resonate at a frequency between approximately 30-36 Hz. If the oscillating platform apparatus is to be designed for the treatment of animals, the spring 122 can be sized to resonate at a frequency up to 120 Hz. An oscillating platform apparatus configured to oscillate at approximately 30-36 Hz utilizes a compression spring with a spring constant (k) of approximately 9 pounds (lbs.) per inch in the embodiment shown. In other configurations of an oscillating platform apparatus, oscillations of a similar range and frequency can be generated by one or more springs, or by other devices or mechanisms designed to create or otherwise dampen an oscillation force to a desired range or frequency.

FIG. 2 is a side sectional view taken along line 1-1 in FIG. 1, and partially cut away to show details of the connection of the oscillating actuator 110 to the drive lever 114. The drive lever 114 includes an elongate slot 148 (shown in FIGS. 1 and 3) for receiving connectors 116. The elongate slot 148 permits the oscillating actuator 110 to be selectively positioned along a portion of the length of the drive lever 114. The connectors 116 can be manually adjusted to position the oscillating actuator 110 with respect to the drive lever 114, and then readjusted when a desired position for the oscillating actuator 110 is selected along the length of the elongate slot 148. By adjusting the position of the oscillating actuator 110, the vertical movement or displacement of the drive lever 114 can be adjusted. For example, if the oscillating actuator 110 is positioned towards the drive lever pivot point 118, then the vertical movement or displacement of the drive lever 114 at the opposing end near the spring 122 will be relatively greater than when the oscillating actuator 110 is positioned towards the spring. Conversely, as the oscillating actuator 110 is positioned towards the spring 122, the vertical movement or displacement of the drive lever 114 at the opposing end near the spring 122 will be relatively less than when the oscillating actuator 110 is positioned towards the drive lever pivot point 118.

FIG. 3 is an exploded perspective view of the oscillating platform apparatus 100 shown in FIG. 1, and is partially cut away to show the internal mechanism of the platform 100. In this embodiment as well as other embodiments, the oscillating platform apparatus 100 is contained within a housing 102. The housing 102 can be made from any material sufficiently strong for the purposes described herein, e.g. any material that can bear the weight of a patient on the upper plate. For example, suitable materials can be metals, e.g. steel, aluminum, iron, etc.; plastics, e.g. polycarbonates, polyvinylchloride, acrylics, polyolefins, etc.; or composites; or combinations of any of these materials.

Also shown in this embodiment is a series of holes 150 machined through the upper plate 104 of the platform 100. The holes 150 are arranged parallel with each of the primary distributing lever 140 and secondary distributing levers 132. These holes 150 (also shown in FIG. 1) provide different points of connection or attachment for contact points 146, thereby varying the points at which these contact points contact the distributing levers 132, 140, and thus the amount of lever arm and mechanical advantage used in driving the upper plate 104 to vibrate.

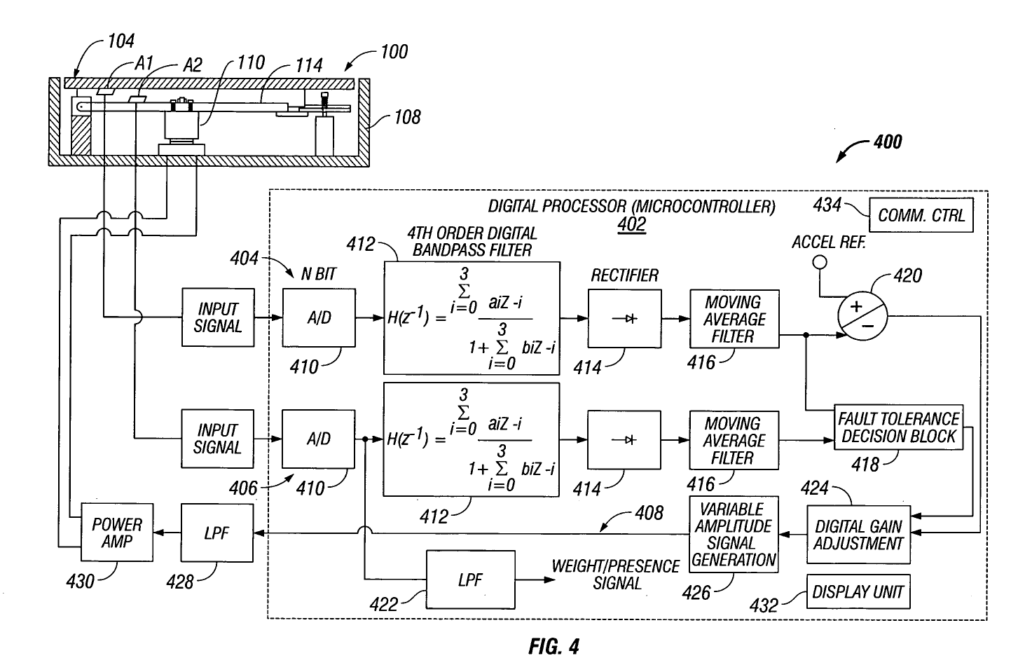

As shown in FIG. 2, an accelerometer A1 is positioned on an underside surface of the upper plate 104 for transmitting at least one signal relaying patient acceleration information to a digital signal processor 402 as shown in FIG. 4. The acceleration information is processed by the processor 402 for determining the acceleration of the patient either standing on the upper plate 104 or being supported by a support structure resting on the platform 100 in real time. The processor 402 can be housed within the platform 100.

The processor 402 transmits a feedback signal to an oscillating actuator 110. The feedback signal is preferably a sine wave whose amplitude is adjusted for maintaining a predetermined number used for automatic gain control (closed loop control) within a predetermined range having predetermined upper and lower limits. The digital signal processor 402 adds the predetermined number and the acceleration of the patient continuously or periodically during dynamic motion therapy to determine the average acceleration of the patient over time. The average acceleration is stored within a memory of the processor 402 to be used for patient monitoring and other purposes.

A second accelerometer A2 is mounted to the drive lever 114 and transmits at least one signal relaying tilt information to the digital signal processor 402 as shown in FIG. 4. Accelerometer A2 performs the functions of a patient sensing device (determines presence of patient), weight monitoring sensor, transmissibility (dynamic stiffness) coefficient sensor, and patient compliance monitor. Accelerometer A2 transmits a first angular measurement to the digital signal processor 402 after power-on and before the patient stands on the upper plate 104 (or is supported by a support structure resting on the platform 100). This angular measurement is used to determine the initial angle of the upper plate 104 which is dependent on the actual horizontality of the installation surface upon which the oscillating platform apparatus 100 rests. Another angular measurement is received by the digital signal processor 402 from accelerometer A2 after the patient stands on the upper plate 104 (or is supported by the support structure resting on the platform 100) and before the oscillating actuator 110 is actuated. This angular measurement is used together with the other angular measurement for calibrating the oscillating platform apparatus 100 and for calculating the mass or weight of the patient using conventional weight/angle equations. The weight is preferably stored in a memory of the digital processor 402.

It is contemplated that if the digital signal processor 402 has not received patient acceleration information or angular measurements after a predetermined time period from the respective accelerometers A1, A2, the digital signal processor 402 turns off the oscillating actuator 110. This conserves power when a patient is not standing on the oscillating platform apparatus 100 or being supported by the support structure, such as a seat or exercise equipment, resting on the oscillating platform apparatus 100.

During dynamic motion therapy, the digital signal processor 402 determines and monitors the weight of the patient. The weight of the patient is continuously in real time or periodically compared to the original stored weight to determine the posture of the patient and accordingly, the transmissibility of the mechanical vibration energy through the patient or oscillating platform apparatus-seat/support structure-patient interface, since the posture of the patient and dynamic stiffness of the seat/support structure affects the transmissibility of the mechanical vibration energy through the patient.

If the calculated weight during dynamic motion therapy differs significantly (i.e., more than a predetermined threshold) from the original stored weight, the digital signal processor 402 determines that the patient's posture changed thereby decreasing or increasing the transmissibility of the mechanical vibration energy depending on whether the weight decreased (transmissibility decreased) or increased (transmissibility increased). If the weight decreased, it can be assumed that the patient has deviated from or is not compliant with the dynamic motion therapy treatment protocol. Accordingly, by adjusting the posture of the patient and/or dynamic stiffness of the seat (or other support structure) resting on the oscillating platform apparatus 100 (see FIG. 8), the calculated weight can be made to approximate the original stored weight, and thus, the transmissibility of the mechanical vibration energy through the patient or oscillating platform apparatus-seat/support structure-patient interface 800 (see FIG. 8) can be influenced, as well as dynamic loading, for maximizing the treatment effects caused by dynamic motion therapy.

With reference to FIG. 4, there is shown a schematic block diagram of the dynamic motion therapy system 400 in accordance with the disclosure. The dynamic motion therapy system 400 includes platform 100 having two accelerometers A1, A2 for transmitting information to the digital signal processor 402. The digital signal processor 402 includes primarily two incoming data paths 404, 406 having identical components for processing data received from the two accelerometers A1, A2 and one outgoing data path 408 for relaying control or feedback signals to the oscillating actuator 110.

The digital signal processor 402 includes a memory storing a set of programmable instructions capable of being executed by the digital signal processor 402 for operating the components of the two incoming data paths 404, 406 and one outgoing data path 408 for performing the functions described above in accordance with the disclosure, as well as other functions. The set of programmable instructions can also be stored on a computer-readable medium, such as a CD-ROM, diskette, and other magnetic media, and downloaded to the digital signal processor 402.

Each incoming data path includes four major components for processing the incoming data from the two accelerometers A1, A2. The four major components are in order from left to right in FIG. 4 an analog-to-digital (A/D) converter 410, a bandpass filter 412, a rectifier 414, a moving average filter 416, and a fault tolerance decision block 418.

Preferably, the bandpass filter 412 in each incoming data path is a 4^{th} order elliptic bandpass filter which finds the “sweet spot” for each particular patient (this causes the processor to shift the resonance of the dynamic therapy system 400 based on the patient's mass or weight by transmitting a signal to the oscillating actuator 110 to change the frequency of the oscillating force). The digital signal processor 402 processes the polynomial coefficients of the 4^{th} order elliptic bandpass filters by implementing “power of two” coefficients. The processor 402 is programmed to do this instead of performing polynomial multiplication for each coefficient in the polynomial which would require a significantly longer processing time. The processor 402 in accordance with the present disclosure reduces processing time by approximating the polynomial coefficients using the “power of two.” For example, if the coefficient is 3.93215, the processor 402 can perform a quick approximation of the coefficient by approximating the coefficient as follows: 4−1/16+3/128−1/512. It is contemplated that the same method can be used to process the coefficients of the other filters of the processor 402.

The output from the moving average filter 416 of incoming data path 404 is provided to the fault tolerance decision block 418 for determining fault tolerance level and an adder/subtracter block 420 for deciding whether to increase or decrease the gain to maintain the average vibration intensity to a preset value. The output of block 420 is an error signal which determines whether to increase or decrease the vibration level of the oscillating actuator 110.

The output from the adder/subtractor block 420 is the acceleration of the patient and the output from A/D converter 410 of incoming data path 406 is provided to a low-pass filter 422 which outputs a weight/presence signal. The weight/presence signal is used to sense the presence of the patient and to calculate the weight of the patient continuously or periodically using conventional weight/angle equations during dynamic motion therapy.

By determining the weight of the patient during treatment and comparing the weight to the original stored weight as described above, the processor 402 is able to determine whether the patient is compliant with the treatment protocols (e.g., proper stance or position) and the posture of the patient for determining the transmissibility of the mechanical vibration energy through the patient. The patient can then influence the transmissibility, if necessary (i.e., if the calculated weight indicates poor transmissibility), by shifting or changing his posture accordingly.

The acceleration value of the patient and the output from the fault tolerance decision block 418 are inputs at separate times (since the processor 402 of the dynamic motion therapy system 400 is designed as a real time interrupt driven software system as described below) during operation of the dynamic therapy system 400 to the outgoing data path 408.

The outgoing data path 408 includes four major components for processing control and feedback signals transmitted from the processor 402 to the oscillating actuator 110. The four major components are in order from right to left in FIG. 4 a digital gain adjustment module 424 for performing automatic gain control as described above, a variable amplitude signal generation module 426 for increasing or decreasing the sinusoidal signal driving the oscillating actuator 110, a low-pass filter 428 for filtering the control and feedback signals and a power amplifier 430 for amplifying the control and feedback signals.

The system 400 includes a display unit 432 for displaying treatment-related information and other information, such as diagnostic information, to the patient, medical professional or other individual. The treatment-related information can include the original calculated weight of the patient and the calculated weight of the patient during treatment, the acceleration of the patient, automatic gain control information, level or degree of compliance to the treatment protocols, a transmissibility value indicating or approximating the transmissibility of the mechanical vibration energy, etc.

The digital signal processor 402 of the dynamic motion therapy system 400 is designed as a real time interrupt driven software system (the system 400 does not have a main loop). A timer interrupt occurs every 1/fs milliseconds. That is, for example, if the system 400 is tuned at 34 Hz, a timer interrupt occurs every 1/34 seconds. A different function occurs during each timer interrupt, such as replenishing or updating the display unit 432, transmitting the control or feedback signals to the oscillating actuator 110, and generating a transmitting a sine wave to the oscillating actuator 110 for automatic gain control (the sine wave is preferably generated and transmitted approximately 500 times per second). It is contemplated that higher priority interrupts are performed first. If there is not interrupt to be performed, the processor 402 goes into an idle mode until there is an interrupt to perform.

The digital signal processor 402 generates the (sinusoidal) signal to the oscillating actuator 110 and processes the acceleration signal received from accelerometer A1 using at least one digital bandpass filter 412 with a variable sampling rate during calibration (tuning) of the dynamic motion therapy system 400. In the dynamic motion therapy system 400, the sampling rate and thus the vibration frequency is between 0 and 250 Hz, with the at least one digital bandpass filter 412 adaptively tuned to the current operating frequency. The variable sampling rate is possible due to the interrupt driven software system of the software control loop as described above.

The dynamic therapy system 400 further includes communication circuitry 434 for downloading/uploading data, including software updates, to the processor 402 and for communicating with a central monitoring station via a network, such as the Internet, including receiving Internet content. The communication circuitry 434 can include RS232, USB, parallel and serial ports and associated circuitry, as well as network connection software and circuitry, such as a modem, DSL connection circuitry, etc. Preferably, the process of downloading/uploading data, including software updates, is configured as an interrupt for being performed during a timer interrupt by the dynamic therapy system 400.

Patient compliant data (directed to whether the patient is complying to treatment protocols) and other patient- and treatment-related data are preferably stored in the dynamic therapy system 400 for evaluation at a later time or for transmission via the network using the communications circuitry 434 to the central monitoring station for observation. The transmission can also occur in real time during dynamic motion therapy for enabling a medical professional or other observer to transmit data via the network to the patient during the therapy session. The transmitted data can be displayed to the patient on the display unit 432 and/or audibly played via a speaker.

The transmitted data can include a message for the patient to change his posture for maximizing mechanical impedance and the transmissibility of the mechanical vibration energy through the patient. Another transmitted message can be for the patient to manually change one or more operating parameters of the dynamic therapy system 400.

The data transmitted from the dynamic therapy system 400 can include video and/or sensor data obtained by a video camera and/or at least one sensor mounted to the support structure or the dynamic therapy system 400 and transmitted via the network to the central monitoring station.

Using the dynamic therapy system 400 and mechanical impedance methods as known in the art, one can predict the transmissibility of the mechanical vibration energy through the patient being supported by a support structure, such as a kneeling chair-type support structure (see FIGS. 6-8), wheel chair, seat, exercise device, etc., using the dynamic stiffness of the support structure and the apparent mass of the body measured at appropriate vibration magnitudes. The materials, structure, orientation, etc. of the support structure can then be selected and re-designed for maximizing the transmissibility of the mechanical vibration energy through the oscillating platform apparatus-support structure-patient interface in order to maximize the transmissibility of the mechanical vibration energy through the patient. The support structure can in effect be custom designed for each patient for maximizing the transmissibility of the mechanical vibration energy through the patient.

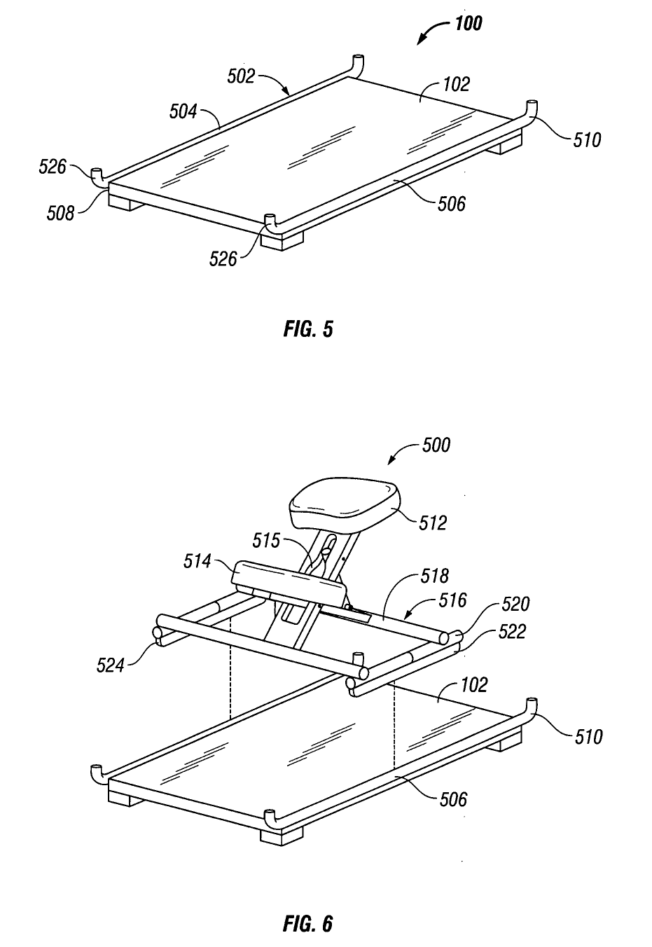

With reference to FIG. 5, oscillating platform apparatus 100 includes a supporting mechanism 502 for receiving a support structure 500 (see FIG. 6). The supporting mechanism 502 includes support bars 504 and 506 mounted at corresponding outboard sides 508 and 510 of oscillating platform apparatus 100 for receiving the support structure as further described below

With reference to FIGS. 6-8, the support structure is a kneeling chair supplemental support structure designated generally by reference numeral 500. Support structure 500 includes a seat 512 and a kneeling pad 514 mounted to a frame 516 (FIG. 6). The kneeling chair support structure 500 can further include a seat adjustment mechanism 515 for adjusting the height range of the seat 512.

The frame 516 of the support structure 500 includes a first pair of support members 518 for supporting seat 512 and kneeling pad 514; and a second pair of support members 518 each mounted to a support bar 520. A rail bar 522, 524 is respectively mounted to each support bar 520. Each support bar 520/rail bar 522, 524 combination press fits or wedges against the outer surface of a support bar 504, 506 for rigidly or sturdily mounting the support structure 500 to the platform apparatus 100.

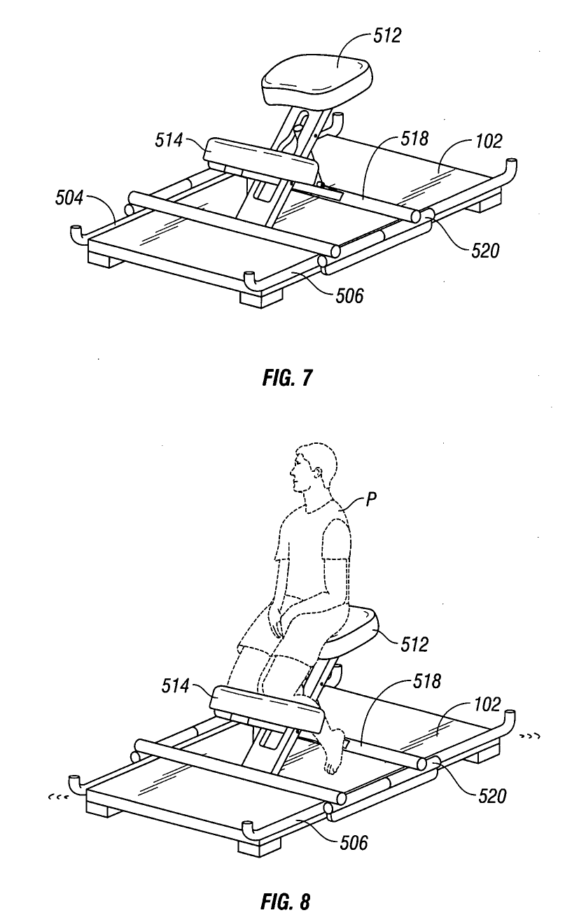

After the kneeling chair supplemental support structure 500 is mounted to the platform apparatus 100, as shown by FIGS. 7 and 8, a portion of the frame 516 contacts the non-rigidly supported upper plate 104 of oscillating platform apparatus 100.

With reference to FIG. 8, during operation of the oscillating platform apparatus 100 for treating a patient P suffering from, for example, postural instability or other condition, support structure 500 is caused to vibrate by oscillating platform apparatus 100 and perturbations or vibrations caused by oscillating platform apparatus 100 are transferred to patient P directly from the oscillating platform apparatus 100, as well as directly through support structure 500.

A patient suffering from a severe case of postural instability or other condition which prevents the patient from standing on the oscillating platform apparatus 100 can be seated on the seat 512 of the kneeling chair support structure 500 and be treated with the oscillating platform apparatus 100. While seated on the seat 512, as shown by FIG. 8, the kneeling chair support structure 500 distributes body weight between the seat 512 and the kneeling pad 514 to minimize pressure points. The kneeling chair support structure 500 helps keep the patient's spine in its natural “S” alignment. Additionally, by easing the hips forward, the kneeling chair support structure 500 encourages an upright posture by aligning the back, shoulder and neck, and thereby easing discomfort and pain to the patient.

It is understood that changes may be made in the particular embodiments disclosed herein which are within the scope and spirit of the disclosure as outlined by the appended claims. Having thus described the disclosed embodiments with the details and particularity required by the patent laws, what is claimed and desired protected by Letters Patent is set forth in the appended claims.

What is claimed is:

1. A support system for providing support to a patient undergoing vibrational treatment, said system comprising:
a dynamic motion therapy device comprising a non-rigidly supported platform capable of providing vibrational treatment to a patient in contact with the non-rigidly supported platform; and
support structure for supporting a patient on said dynamic motion therapy device, at least a portion of the support structure contacting the non-rigidly supported platform.

2. The support system as recited in claim 1, wherein the dynamic motion therapy device includes a supporting mechanism for receiving the support structure.

3. The support system as recited in claim 2, wherein the support structure includes means for rigidly mounting the support structure to the supporting mechanism.

4. The support system as recited in claim 1, wherein said support structure includes a chair comprising a seat mounted to a frame for enabling the patient to seat during the vibrational treatment.

5. The support system as recited in claim 4, wherein the chair is a kneeling chair.

6. An apparatus for therapeutically treating a tissue in a body, the apparatus comprising:
a support structure configured for supporting the body and having a frame;
an oscillating platform apparatus configured to support the support structure and having a non-rigidly supported platform, at least a portion of the support structure contacting the non-rigidly supported platform;
an accelerometer operatively connected to the oscillating platform apparatus for transmitting a signal to a processor for determining the weight of the body being supported on the non-rigidly supported platform;
a lever assembly comprising a pair of substantially parallel levers supported by a distributing lever arm arranged substantially perpendicular with respect to each of the substantially parallel levers; and
an oscillator positioned within the oscillating platform apparatus for supporting the distributing lever arm and configured to impart an oscillating force at a predetermined frequency on the body.

7. The apparatus of claim 6, wherein the oscillator is configured to adjust an amplitude of the frequency of the oscillating force to achieve a desired treatment.

8. The apparatus of claim 6, wherein the oscillator is configured to adjust an amplitude of the frequency of the oscillating force as a function of the determined weight of the body.

9. The apparatus of claim 6, wherein the oscillator is configured such that the frequency of the oscillating force is set to zero when the processor receiving at least one signal from the accelerometer determines that the weight on the platform is equal to zero.

10. The apparatus of claim 6, wherein the oscillator is further configured such that the frequency of the oscillating force is set to a desired level when the processor receiving the signal from the accelerometer determines that the magnitude of the weight being supported on the platform changes from zero to a magnitude which is greater than zero.

11. The apparatus of claim 6, further comprising another accelerometer operatively connected to the oscillating platform apparatus for generating and transmitting a signal representative of the acceleration of the body for determining the acceleration of the body supported by the non-rigidly supported platform by the processor receiving and processing the signal.

12. The apparatus of claim 6, wherein a feedback signal generated by the processor is used to adjust the frequency of the oscillating force based on at least one measured characteristic related to the body.

13. The apparatus of claim 6, wherein the processor includes two bandpass filters each programmed to process polynomial coefficients by approximating the polynomial coefficients by power of two coefficients.
